(19) United States
(12) Patent Application Publication
(10) Pub. No.: US 2024/0100917 A1
(43) Pub. Date: Mar. 28, 2024

(54) FRAME-CHANNEL-INTEGRATED DOOR OF METAL-PLASTIC COMPOSITE MATERIAL

(71) Applicants: Hyundai Motor Company, Seoul (KR); Kia Corporation, Seoul (KR)

(72) Inventor: Je-Won CHOI, Anyang-Si (KR)

(73) Assignees: Hyundai Motor Company, Seoul (KR); Kia Corporation, Seoul (KR)

(21) Appl. No.: 18/202,220

(22) Filed: May 25, 2023

(30) Foreign Application Priority Data
Sep. 27, 2022 (KR) 10-2022-0122781

(51) Int. Cl. B60J 5/04

(52) U.S. Cl. CPC B60J 5/0402; B60J 5/0484

(57) ABSTRACT

A frame-channel-integrated door of a metal-plastic composite material in which a frame channel provided between an external panel and an internal panel is integrally joined to a panel made of plastic material, includes a first panel made of plastic material and positioned on one of an external surface and an internal surface of a vehicle door, a second panel made of metal material and positioned on another one of the external surface and the internal surface of the vehicle door, and a frame channel attached to an internal surface of the first panel, wherein the frame channel is coupled to the outside of a glass run, and the second panel is joined to the outside of the frame channel.

### CROSS-REFERENCE TO RELATED APPLICATION

The present application claims priority to Korean Patent Application No. 10-2022-0122781, filed on Sep. 27, 2022, the entire contents of which is incorporated herein for all purposes by this reference.

### BACKGROUND OF THE PRESENT DISCLOSURE

### Field of the Present Disclosure

The present disclosure relates to a vehicle door to which a plurality of channels is coupled, and more particularly, to a frame-channel-integrated door made of a metal-plastic composite material in which a frame channel provided between an external panel and an internal panel is integrally joined to a panel made of plastic material.

### Description of Related Art

As shown in FIG. 1, FIG. 2, and FIG. 3, typically, a door 110 through which an occupant gets in or out of a vehicle 100 is provided on the lateral side of the vehicle 100.

A frame channel 123 for reinforcing a rigidity of a frame 120 and mounting a glass run 127 is applied to the frame 120 of the door 110.

The door 110 is formed by joining external circumferences of an external panel 121 and an internal panel 122 to each other. On a portion of the door 110 on which the glass run 127 is mounted, the frame channel 123 having a “U”-shaped cross section is coupled to the external panel 121 and the internal panel 122 by performing a hemming process.

The frame channel 123 necessarily has to be mounted to reinforce the rigidity of the frame 120 and to mount the glass run 127. To the present end, high-priced roll-forming mold and three-dimensional bending mold have to be manufactured to manufacture the frame channel 123. For the present reason, it requires much time and costs to develop vehicles, such as a purpose-built vehicle (PBV), that are suitable for diversified small-quantity production.

Furthermore, while a three-dimensional stretch bending is performed on the frame channel 123, there occurs some distributions from the standard quality of the frame channel 123. There also occurs some distributions from the standard quality for assembling during a process of assembling the frame channel 123 to each of the external channel 121 and the internal panel 122. The degree of distributions from a provided quality standard is accumulated. As a result, quality problems occur such as a gap between the glass run 127 and a door glass 128, displacement of the glass run 127 and the door glass 128 from their original positions, and excessive pressing of the glass run 127. As indicated by an arrow in FIG. 3, these problems cause noise, ambient air, or moisture to be introduced into the vehicle 100 from the outside.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a frame-channel-integrated door of a metal-plastic composite material in which a frame channel is integrally formed with a plastic panel and a metal panel and a plastic panel are coupled to each other.

To accomplish the above-mentioned object, according to an aspect of the present disclosure, there is provided a frame-channel-integrated door of a metal-plastic composite material including: a first panel made of plastic material and positioned on one of an external surface and an internal surface of a vehicle door; a second panel made of a metal material and positioned on another one of the external surface and the internal surface of the vehicle door; and a frame channel attached to an internal surface of the first panel, wherein the frame channel is coupled to the outside of a glass run, and the second panel is joined to the outside of the frame channel.

In the frame-channel-integrated door of a metal-plastic composite material, the frame channel may be joined to the internal surface of the first panel, starting from an upper end portion of the first panel in a frame of the vehicle door and ending at a lower end portion of the first panel.

In the frame-channel-integrated door of a metal-plastic composite material, jaw portions onto which a rib of a glass run may be hooked may be formed on the frame channel.

In the frame-channel-integrated door of a metal-plastic composite material, a stopper that restricts a position of an upper end portion of the second panel may be formed on an upper end portion of the frame channel.

In the frame-channel-integrated door of a metal-plastic composite material, the frame channel may include: a first channel member attached to the internal surface of the first panel; and a second channel member joined to the first channel member, the first channel member and the second channel member may be coupled to the outside of the glass run, and one side of the second panel may be joined to the first channel member, and the other side thereof may be joined to the second channel member.

In the frame-channel-integrated door of a metal-plastic composite material, the first channel member may be joined to the internal surface of the first panel, starting from an upper end portion of the first panel in a frame of the vehicle door and ending at a lower end portion of the first panel.

In the frame-channel-integrated door of a metal-plastic composite material, a coupling protrusion may be formed on one of the first channel member and the second channel member, a coupling groove into which the coupling protrusion is inserted may be formed in another one of the first channel member and the second channel member, and the coupling protrusion may be inserted into the coupling groove, being joined thereto, and thus the first channel member and the second channel member may be coupled to each other.

In the frame-channel-integrated door of a metal-plastic composite material, the coupling protrusion may be formed on the first channel member to face the second channel member therefrom.

In the frame-channel-integrated door of a metal-plastic composite material, the coupling protrusion may be formed so that a height thereof decreases toward an end portion thereof, and the coupling groove may be concavely formed to correspond in shape to the coupling protrusion.

In the frame-channel-integrated door of a metal-plastic composite material, jaw portions onto which a rib of the glass run is hooked may be formed on the first channel member and the second channel member, respectively.

In the frame-channel-integrated door of a metal-plastic composite material, the first channel member and the second channel member may be coupled to each other using an adhesive.

In the frame-channel-integrated door of a metal-plastic composite material, the first channel member and the second channel member may be coupled to each other by thermal melting.

In the frame-channel-integrated door of a metal-plastic composite material door, a first fastening block may be formed and spaced from the coupling protrusion on the first channel member, and a second fastening block may be formed on the second channel member to be brought into contact with the first fastening block, and a fastening member may pass through the second fastening block and may be fastened to the first fastening block.

In the frame-channel-integrated door of a metal-plastic composite material, a stopper that restricts a position of an upper end portion of the second panel may be formed on an upper end portion of the first channel member.

In the frame-channel-integrated door of a metal-plastic composite material, the frame channel may be made of plastic material.

In the frame-channel-integrated door of a metal-plastic composite material, the first panel may be an external panel which is positioned on the external surface of the vehicle door, and the second panel may be an internal panel which is positioned on the internal surface of the vehicle door.

In the frame-channel-integrated door of a metal-plastic composite material with the configuration described above, the material of the frame channel may be changed from the metal material to the plastic material. This change makes it unnecessary to manufacture a high-priced mold and makes it possible to manufacture various types of doors. Thus, the manufacture cost may be reduced.

Furthermore, because the plastic panel and the frame channel are integrated into one piece, positions of the plastic panel and the frame channel are restricted, and the degree of deviation from the quality standard may be decreased, contributing to quality improvement. Accordingly, a phenomenon where noise or ambient air is introduced into a vehicle from the outside thereof may be prevented.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a side view exemplarily illustrating a lateral side of a vehicle in the related art.

FIG. 2 is an exploded perspective view exemplarily illustrating a state where an external panel, a frame channel, and an internal panel are assembled in the present order in the related art.

FIG. 3 is a cross-sectional view taken along line I-I on FIG. 1.

FIG. 4 is a cross-sectional view exemplarily illustrating a structure of a frame of a vehicle door in a frame-channel-integrated metal-plastic composite material door according to various exemplary embodiments of the present disclosure.

FIG. 5A, FIG. 5B, FIG. 5C, and FIG. 5D are cross-sectional views exemplarily illustrating a process of sequentially assembling the frame-channel-integrated metal-plastic composite material door according to the various exemplary embodiments of the present disclosure.

FIG. 6 is a cross-sectional view exemplarily illustrating a A-pillar portion in the frame-channel-integrated metal-plastic composite material door according to the various exemplary embodiments of the present disclosure.

FIG. 7 is a cross-sectional view exemplarily illustrating a B-pillar portion in the frame-channel-integrated metal-plastic composite material door according to the various exemplary embodiments of the present disclosure.

FIG. 8 is a partial cross-sectional perspective view exemplarily illustrating a portion of a structure of a frame of a vehicle door in a frame-channel-integrated metal-plastic composite material door according to various exemplary embodiments of the present disclosure.

FIG. 9 is a cross-sectional view taken along line II-II on FIG. 8.

FIG. 10 is a partial cross-sectional perspective view exemplarily illustrating a state where a first member and a second member are fastened to each other using a screw in the frame-channel-integrated metal-plastic composite material door according to the various exemplary embodiments of the present disclosure.

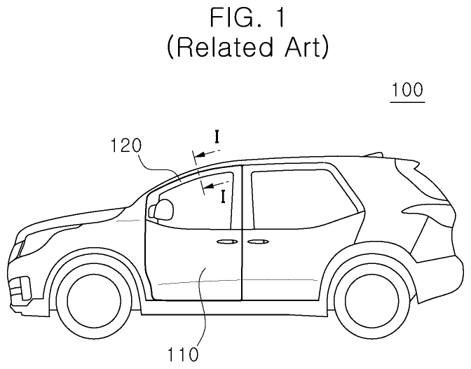

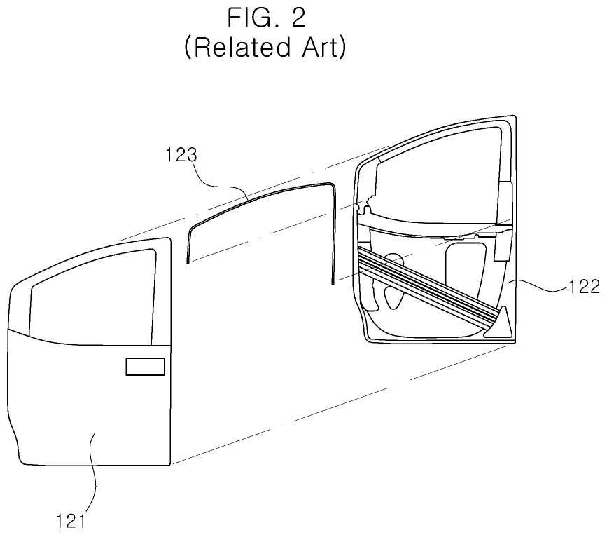

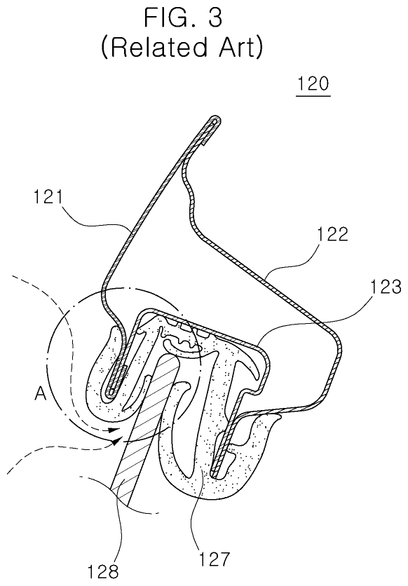

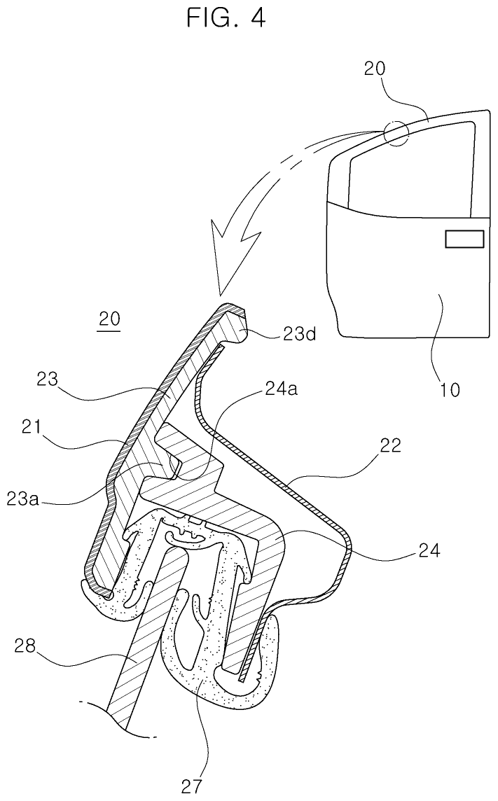

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

A frame-channel-integrated metal-plastic composite material door according to an exemplary embodiment of the present disclosure will be described in detail below with reference to the accompanying drawings.

The frame-channel-integrated metal-plastic composite material door according to an exemplary embodiment of the present disclosure includes: a first panel 21 made of plastic material and positioned on any one of an external surface and an internal surface of a vehicle door 10; a second panel 22 made of metal material and positioned on the other one of the external surface and the internal surface of the vehicle door 10; and a frame channel 23 and 24 which may be attached to an internal surface of the first panel 21, wherein the frame channel 23 and 24 may be coupled to the outside of a glass run 27, and the second panel 22 may be joined to the outside of the frame channel 23 and 24.

An external panel 21 and the internal panel 22, each of which is formed into a predetermined shape, may be joined to each other to form the vehicle door 10. Typically, the external panel 21 and the internal panel 22 may be manufactured from a metal panel. However, when the external panel 21 and the internal panel 22 are manufactured from only a metal panel, even though a shape of the vehicle door 10 is slightly changed, it takes much time and money to newly manufacture a mold for manufacturing the external panel 21 or the internal panel 22. Because of the present problem, the external panel 21 and the internal panel 22 that are manufactured from a metal panel may not be suitable for diversified small-quantity production of vehicles.

Accordingly, according to an exemplary embodiment of the present disclosure, any one of the external panel 21 and the internal panel 22 may be made of plastic material. Accordingly, when the shape of the vehicle door 10 is changed, a new injection mold is applicable with relatively less time and money.

An example will be described below where one of the external panel 21 and the internal panel 22, the external panel 21, may be made of plastic material, and the other one, the internal panel 22, may be made of metal material.

Plastic material may be injection-molded into a predetermined shape of the external panel 21. A portion of the external panel 21 that corresponds to a frame 20 of the vehicle door 10 includes the upper and lower end portions thereof that extend inwardly.

The internal panel 22 may be made from a metal panel.

In a case where, as described above, any one of the external panel 21 and the internal panel 22 may be made of plastic material, the frame channel 23 and 24, which is to be mounted between the external panel 21 and the internal panel 22, may be made of the same plastic material as the external panel 21 and may be joined to the external panel 21. That is, the frame channel 23 and 24 may be joined to the internal surface of the first panel 21, starting from an upper end portion of the first panel 21 in the frame 20 of the vehicle door 10 and ending at a lower end portion thereof.

The frame channel 23 and 24 may be integrally formed into one piece. However, the frame channel 23 and 24 includes a first channel member 23 and a second channel member 24, respectively. The first channel member 23 may be attached to an internal surface of the external panel 21, and the second channel member 24 may be joined to the first channel member 23. Moreover, the outside of the glass run 27 is coupled to the first channel member 23 and the second channel member 24. Furthermore, one side of the internal panel 22 may be joined to the first channel member 23, and the other side thereof is joined to the second channel member 24.

The first channel member 23 may be joined to the internal surface of the first panel 21, starting from an upper end portion of the external panel 21 in the frame 20 of the vehicle door 10 and ending at a lower end portion thereof. The upper and lower end portions of the external panel 21 may extend inwardly, and thus may hold upper and lower end portions of the first channel member 23, respectively, tightly. The upper and lower end portions of the external panel 21 may extend over a predetermined distance inward toward the vehicle center. The inward-extending portions may hold the upper and lower end portions of the first channel member 23, respectively, tightly, and thus the first channel member 23 may be prevented from freely moving in the upward-downward direction in the external panel 21.

The first channel member 23 and the second channel member 24 may be coupled to each other using structures of a coupling protrusion 23a and the coupling groove 24a. For example, the coupling protrusion 23a may be formed on the first channel member 23, and the coupling groove 24a in which the coupling protrusion 23a may be inserted is formed in the second channel member 24.

That is, the coupling protrusion 23a may be formed on the first channel member 23 to face the second channel member 24 therefrom, and the coupling groove 24a may be formed to correspond in shape to the coupling protrusion 23a.

For example, the coupling protrusion 23a may be formed so that a height thereof decreases toward an end portion thereof, and the coupling groove 24a may be concavely formed to correspond in shape to the coupling protrusion 23a.

In the present manner, the first channel member 23 and the second channel member 24, when coupled to each other, may form one frame channel 23 and 24.

Jaw portions 23b and 24b onto which a rib of the glass run 27 is hooked may be formed on the frame channel 23 and 24. For example, the jaw portions 23b and 24b may be formed on the first channel member 23 and the second channel member 24, respectively, so that the rib of the glass run 27 is hooked onto the jaw portions 23b and 24b. Thus, the glass run 27 may be prevented from deviating from the first channel member 23 and the second channel member 24 after being coupled thereto. That is, the first jaw portion 23b and the second jaw portion 24b may be formed on the first channel member 23 and the second channel member 24, respectively, and the rib of the glass run 27 may be hooked onto each of the first jaw portion 23b and the second jaw portion 24b.

The first channel member 23 and the second channel member 24 may be coupled to each other using an adhesive or by thermal melting.

A stopper 23d may be formed on an upper end portion of the first channel member 23. When the internal panel 22 is coupled to the first channel member 23, the stopper 23d may restrict a position of an upper end portion of the second panel 22.

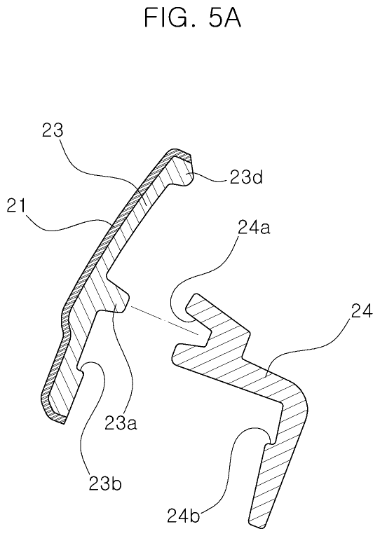

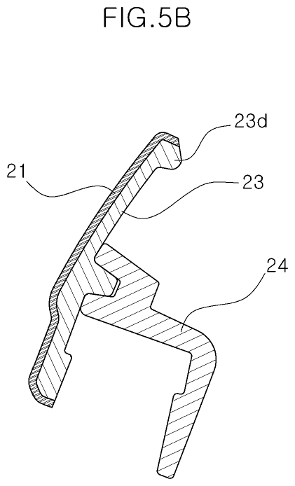

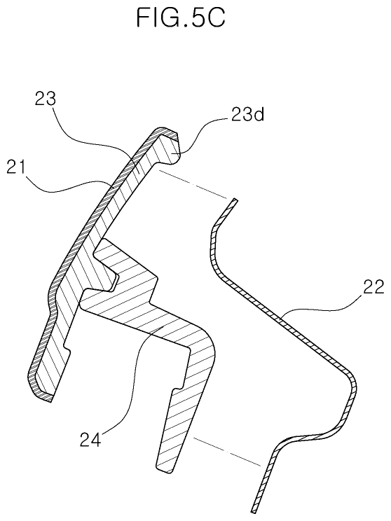

FIG. 5A, FIG. 5B, FIG. 5C, and FIG. 5D illustrate an example where the first panel 21, the second panel 22, the first channel member 23, and the second channel member 24 are assembled.

First, the first panel 21 and the first channel member 23 may be provided in a state where they are joined to each other, and the second channel member 24 may be coupled to the first channel member 23 (refer to FIG. 5A and FIG. 5B). The first channel member 23 and the second channel member 24 may be coupled to each other using an adhesive or by thermal melting.

Subsequently, the second panel 22 may be joined to the first channel member 23 and the second channel member 24 (refer to FIGS. 5C and 5D). The upper end portion of the second panel 22 may be joined to an upper portion of the first channel member 23, and a lower end portion of the second panel 22 may be joined to an external surface of a lower end portion of the second channel member 24.

After the assembling is finished as described above, the glass run 27 may be assembled. Thus, an external edge portion of the door glass pane 28 may be supported.

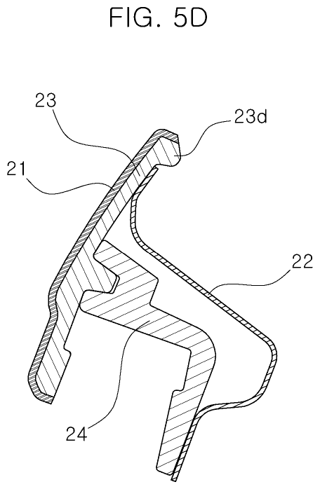

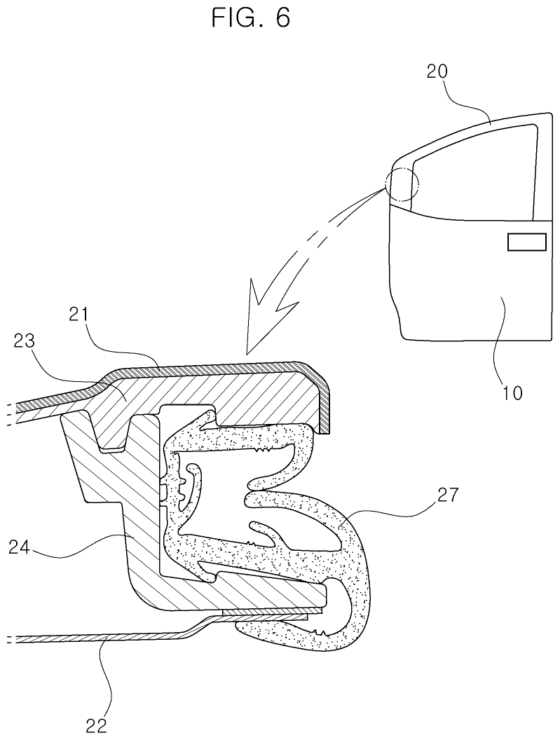

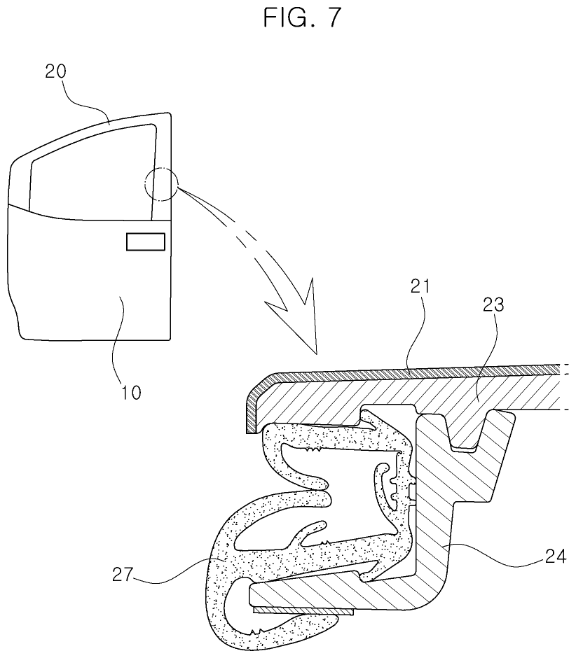

A portion of the vehicle door 10 which is adjacent to the A-pillar, as well as a region of a frame of the vehicle door 10 that corresponds to a roof, may employ the structure described above (refer to FIG. 6). Moreover, a portion of the vehicle door 10 which is adjacent to the B-pillar may also employ the structure as described above (refer to FIG. 7).

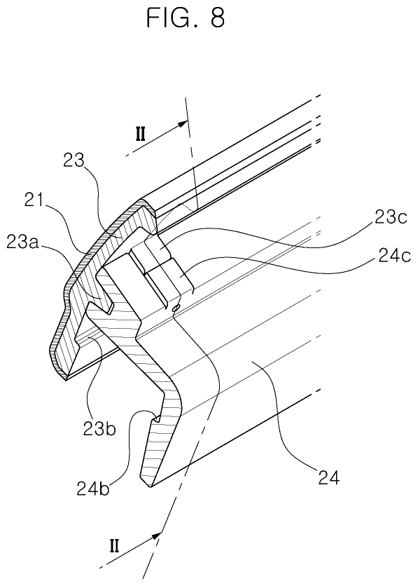

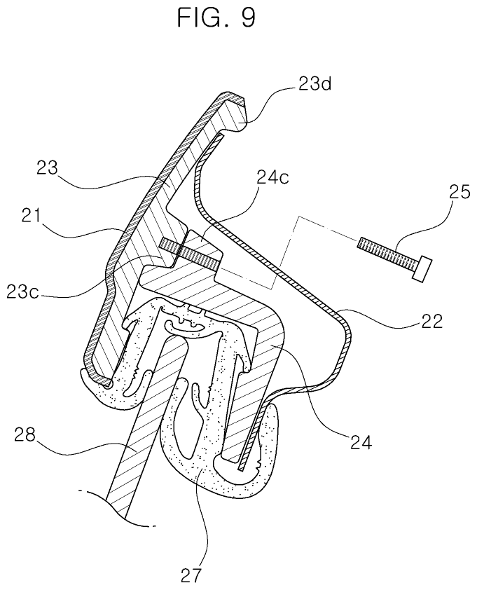

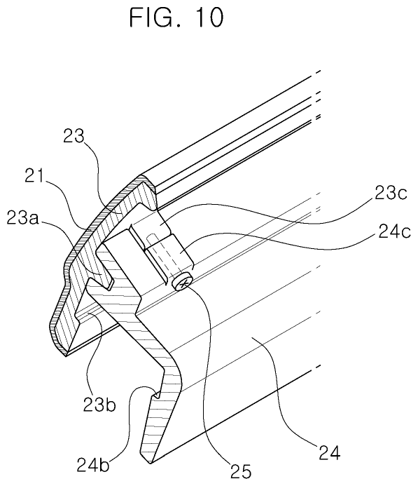

FIG. 8, FIG. 9 and FIG. 10 illustrate that the first channel member 23 and the second channel member 24 are more tightly coupled to each other in a frame-channel-integrated metal-plastic composite material door according to various exemplary embodiments of the present disclosure.

In the frame-channel-integrated metal-plastic composite material door according to the various exemplary embodiments of the present disclosure, a first fastening block 23c may be formed and spaced from the coupling protrusion 23a on the first channel member 23, and a second fastening block 24c may be formed on the second channel member 24 to be brought into contact with the first fastening block 23c.

In a state where the first fastening block 23c and the second fastening block 24c are primarily coupled to each other so that they are brought into contact with each other, a fastening member, for example, a screw 25, may pass through the second fastening block 24c and may be fastened to the first fastening block 23c, and thus the first fastening block 23c and the second fastening block 24c may be more tightly coupled to each other.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A frame-channel-integrated door of a metal-plastic composite material, the frame-channel-integrated door comprising:
a first panel made of plastic material and positioned on one of an external surface and an internal surface of a vehicle door;
a second panel made of metal material and positioned on another one of the external surface and the internal surface of the vehicle door; and
a frame channel attached to an internal surface of the first panel,
wherein the frame channel is coupled to the outside of a glass run, and the second panel is joined to the outside of the frame channel.

2. The frame-channel-integrated door of claim 1, wherein the frame channel is joined to the internal surface of the first panel, starting from an upper end portion of the first panel in a frame of the vehicle door and ending at a lower end portion of the first panel.

3. The frame-channel-integrated door of claim 1, wherein jaw portions onto which a rib of the glass run is hooked are formed on the frame channel.

4. The frame-channel-integrated door of claim 1, wherein a stopper restricting a position of an upper end portion of the second panel is formed on an upper end portion of the frame channel.

5. The frame-channel-integrated door of claim 1, wherein the frame channel includes:
a first channel member attached to the internal surface of the first panel; and
a second channel member joined to the first channel member,
wherein the first channel member and the second channel member are coupled to the outside of the glass run, and
wherein a first side of the second panel is joined to the first channel member, and a second side of the second panel is joined to the second channel member.

6. The frame-channel-integrated door of claim 5, wherein the first channel member is joined to the internal surface of the first panel, starting from an upper end portion of the first panel in a frame of the vehicle door and ending at a lower end portion of the first panel.

7. The frame-channel-integrated door of claim 5,
wherein a coupling protrusion is formed on one of the first channel member and the second channel member,
wherein a coupling groove into which the coupling protrusion is inserted is formed in another one of the first channel member and the second channel member, and
wherein the coupling protrusion is inserted into the coupling groove, being joined thereto, and thus the first channel member and the second channel member are coupled to each other.

8. The frame-channel-integrated door of claim 7, wherein the coupling protrusion is formed on the first channel member to face the second channel member therefrom.

9. The frame-channel-integrated door of claim 7,
wherein the coupling protrusion is formed so that a height thereof decreases toward an end portion of the coupling protrusion, and
wherein the coupling groove is concavely formed to correspond in shape to the coupling protrusion.

10. The frame-channel-integrated door of claim 5, wherein jaw portions onto which a rib of the glass run is hooked are formed on the first channel member and the second channel member, respectively.

11. The frame-channel-integrated door of claim 5, wherein the first channel member and the second channel member are coupled to each other using an adhesive.

12. The frame-channel-integrated door of claim 5, wherein the first channel member and the second channel member are coupled to each other by thermal melting.

13. The frame-channel-integrated door of claim 5,
wherein a first fastening block is formed and spaced from a coupling protrusion on the first channel member, and a second fastening block is formed on the second channel member to be brought into contact with the first fastening block, and
wherein a fastening member passes through the second fastening block and is fastened to the first fastening block.

14. The frame-channel-integrated door of claim 5, wherein a stopper restricting a position of an upper end portion of the second panel is formed on an upper end portion of the first channel member.

15. The frame-channel-integrated door of claim 1, wherein the frame channel is made of plastic material.

16. The frame-channel-integrated door of claim 1,
wherein the first panel is an external panel which is positioned on the external surface of the vehicle door, and
wherein the second panel is an internal panel which is positioned on the internal surface of the vehicle door.

17. A vehicle including the frame-channel-integrated door of the metal-plastic composite material of claim 1.

18. The vehicle of claim 17, wherein the frame channel includes:
a first channel member attached to the internal surface of the first panel; and
a second channel member joined to the first channel member,
wherein the first channel member and the second channel member are coupled to the outside of the glass run, and
wherein a first side of the second panel is joined to the first channel member, and a second side of the second panel is joined to the second channel member.

19. The vehicle of claim 18,
wherein a coupling protrusion is formed on one of the first channel member and the second channel member,
wherein a coupling groove into which the coupling protrusion is inserted is formed in another one of the first channel member and the second channel member, and
wherein the coupling protrusion is inserted into the coupling groove, being joined thereto, and thus the first channel member and the second channel member are coupled to each other.

20. The vehicle of claim 19,
wherein the coupling protrusion is formed so that a height thereof decreases toward an end portion of the coupling protrusion, and
wherein the coupling groove is concavely formed to correspond in shape to the coupling protrusion.
